(19) United States
(12) Patent Application Publication
(10) Pub. No.: US 2018/0230710 A1
(43) Pub. Date: Aug. 16, 2018

(54) Tamper-Resistant Lock

(71) Applicant: Vision Industries Group, Inc., So. Plainfield, NJ (US)

(72) Inventors: Luke Liang, So. Plainfield, NJ (US); Tong Liang, Guangzhou (CN); David Chen, Guangzhou (CN); Troy A. Kirkland, Altoona, PA (US)

(73) Assignee: Vision Industries Group, Inc., So. Plainfield, NJ (US)

(21) Appl. No.: 15/434,371

(22) Filed: Feb. 16, 2017

(51) Int. Cl. E05B 17/20; E05B 65/08; E05B 9/02; E05C 3/04; E05B 63/18

(52) U.S. Cl. CPC E05B 17/2057; E05B 65/08; E05B 63/18; E05C 3/046; E05B 9/02

(57) ABSTRACT

A tamper-proof lock includes: a housing, shaft/handle, cam, lever, spring, and plate. The shaft is pivotally mounted in a housing orifice, with the cam pivotally mounted to the shaft. The cam has first and second shaped openings at first and second respective radial positions, and an arcuate recess. The lever is secured to the shaft, and has a protrusion that alternately engages each of first and second ends of the arcuate recess to respectively/selectively drive the cam to rotate/counter-rotate in first and second directions, into locked and unlocked cam positions. The spring biases the plate for a protrusion thereon to be respectively received within each of first and second shaped cam openings, when aligned therewith at those cam positions, and for a curved surface of the plate to be correspondingly received within first and second curved cam recesses, respectively, when aligned therewith, which facilitate withdrawal of the plate protrusion.

### FIELD OF THE INVENTION

The present invention is directed to the field of window locks, and more particularly is directed to a sash window lock that is configured to be tamper-resistant.

### BACKGROUND OF THE INVENTION

Single hung and double hung sliding windows are known in the art, and are often utilized in the construction of homes and other dwellings, and even offices. Sash locks are typically used to secure the lower sash window in a closed position, if the upper sash is not moveable, or may be used to secure both the upper and lower sash windows in a closed position, where both are slidable within a master window frame. Most sash locks are mounted to the meeting rail of the lower sash window, and use a rotatable cam that may engage a keeper in a locked position, which keeper may be attached to the upper sash window or to the master window frame.

The lock of the present invention is particularly configured for the cam, that locks and engages the keeper, to be tamper-resistant with respect to a person attempting to manipulate the cam from the exterior.

### OBJECTS OF THE INVENTION

It is an object of the invention to provide a lock that is capable of locking the lower sash of a sliding sash window, or of locking both the upper sash and the lower sash window, where both sashes are slidable.

It is another object of the invention to provide a cam window lock capable of locking one or more sashes of a sliding sash window.

It is a further object of the invention to provide a latch for preventing the cam of the sash lock from being surreptitiously operated by an unauthorized party on the outside of the window.

Further objects and advantages of the invention will become apparent from the following description and claims, and from the accompanying drawings.

### SUMMARY OF THE INVENTION

This Summary is provided to introduce a selection of concepts in a simplified form that are further described below in the Detailed Description. This Summary is not intended to identity key features or essential features of the claimed subject matter, nor is it intended to be used to limit the scope of the claimed subject matter.

In accordance with at least one embodiment of the present invention, a window lock may be configured to be tamper-resistant, and may broadly include a housing, a shaft, a cam, a lever member, a compression spring, and a plate member.

The housing may be formed with a single wall shaped to form an interior surface that defines a cavity, and which wall may terminate in a flat surface configured to be mounted onto the meeting rail. In another embodiment the wall may alternately be formed of a plurality of wall portions. The housing may have an orifice interconnected with the cavity; and an elongated recess formed in the interior surface of the wall;

The shaft may be rotatably mounted in the housing orifice, for a portion of the shaft to protrude into the cavity, and a portion of the shaft to protrude out and away from the exterior surface of the housing. The shaft may be formed with a first curved recess, and a second curved recess, both of which may contribute to the tamper-proof nature of the sash lock.

The cam may be pivotally mounted to the shaft within the housing cavity. The cam may be formed with a first shaped opening and a second shaped opening, at first and second respective positions. The cam may also be formed with an arcuate recess that may have a first end and a second end. The cam may thus be configured to rotate in a first direction out of the housing opening into an extended position where it may engage a keeper secured on an upper sash window or on the master window frame, to lock the sash windows. The cam may also rotate in a second direction from the locked cam position to retract into the housing cavity to unlock the sash windows.

The lock may also include a lever member, a portion of which may be fixedly secured to the shaft. The lever member may be formed to include a protrusion which may be sized and shaped to alternately engage each of the first and second ends of the arcuate recess to respectively drive the cam in each of the first and second directions, respectively.

The plate member may be formed to include a first portion configured to be slidably received within the elongated recess of the housing. One end of the first portion of the plate member may be formed into a curved surface that may be shaped to correspond to the first curved recess, and also the second curved recess in the shaft, which recesses may be formed to have the same shape/envelope. In one embodiment the curved surface may be formed to be a portion of a cylindrical surface. In another embodiment the curved surface may be formed to be a portion of a spherical surface. In a different embodiment, other curved surface shapes may also be suitably utilized. The plate member may be formed with a second portion that may be configured to extend from the first portion of the plate member, and which may be sized and shaped to slidably receive the compression spring thereon. In one embodiment, the second portion may have a cylinder. The plate member may also be formed with a protrusion that may be sized and shaped to be slidably received within the first shaped opening of the cam, and also the second shaped opening of the cam, which may be formed, to be the same as the first shaped opening.

With the above-described arrangement, the compression spring may bias the plate member for the second portion of the plate member to be respectively received within each of the first shaped opening and the second shaped opening of the cam, when rotated to be aligned therewith, and for the curved surface of the plate member to be correspondingly received within the first curved recess and the second curved recess, respectively, when correspondingly rotated to be aligned therewith.

Upon rotating the shaft in the second direction, with the cam in the extended lock position, a transition surface adjacent to the first curved recess of the shaft may engage the curved surface of the plate member to oppose the spring bias to cause the protrusion of the plate member to be withdrawn from the first shaped opening of the cam, to permit the cam to be driven in the second direction by contact from the protrusion of the lever member with one end of its arcuate recess.

Upon rotating the shall in the first direction, with the cam in the retracted position, the transition surface adjacent to the second curved recess of the shaft may engage the curved surface of the plate member to again oppose the spring bias to cause the protrusion of the plate member to be withdrawn from the second shaped opening of the cam, but to now permit the cam to be driven in the first direction by contact from the protrusion of the lever member with a second end of its arcuate recess.

These components and particular features of the above-described lock may be such that the arcuate recess in the cam is configured for the joined shaft and lever member to rotate 50 degrees from the locked cam position in the second direction before the cam is driven by the lever member to co-rotate in the second direction, and may also be configured for the shaft to rotate a total of 140 degrees for the cam to be driven from the locked cam position to the unlocked cam position. The tamper-resistant lock may also be configured for the shaft to rotate 90 degrees in the first direction from the unlocked earn position, before the cam is driven by the lever member to co-rotate in the first direction.

### BRIEF DESCRIPTION OF THE DRAWINGS

The description of the various example embodiments is explained in conjunction with appended drawings, in which:

FIG. 1 is a bottom perspective view of the tamper-resistant sash lock as disclosed herein.

FIG. 1A is an exploded view of the parts that make up the sash lock of FIG. 1.

FIG. 2 is a first top perspective view of the housing used for the sash lock of FIG. 1.

FIG. 3 is a second top perspective view of the housing used for the sash lock of FIG. 1.

FIG. 4 is a front view of the housing used for the sash lock of FIG. 1.

FIG. 5 is a top view of the housing used for the sash lock of FIG. 1.

FIG. 6 is a bottom view of the housing used for the sash lock of FIG. 1.

FIG. 7 is a first end view of the housing used for the sash lock of FIG. 1.

FIG. 8 is a second end view of the housing used for the sash lock of FIG. 1.

FIG. 9 is a rear view of the housing used for the sash lock of FIG. 1.

FIG. 10 is a first bottom perspective view of the housing used for the sash lock of FIG. 1.

FIG. 11 is a second bottom perspective view of the housing used for the sash lock of FIG. 1.

FIG. 12 is the housing bottom view of FIG. 6, but is shown enlarged.

FIG. 13 is a top perspective view of the shaft and handle used for the sash lock of FIG. 1.

FIG. 14 is a first bottom perspective view of the shaft and handle used for the sash lock of FIG. 1.

FIG. 15 is a second bottom perspective view of the shaft and handle used for the sash lock of FIG. 1.

FIG. 16 is a side view of the shaft and handle used for the sash lock of FIG. 1.

FIG. 17 is a top view of the shaft and handle used for the sash lock of FIG. 1.

FIG. 18 is a bottom view of the shaft and handle used for the sash lock of FIG. 1.

FIG. 19 is an end view of the shaft and handle used for the sash lock of FIG. 1.

FIG. 20 is a first perspective view of the cam used for the sash lock of FIG. 1.

FIG. 21 is a second perspective view of the cam used for the sash lock of FIG. 1.

FIG. 22 is a third perspective view of the cam used for the sash lock of FIG. 1.

FIG. 23 is a side view of the cam used for the sash lock of FIG. 1.

FIG. 24 is a top view of the cam used for the sash lock of FIG. 1.

FIG. 25 is a bottom view of the cam used for the sash lock of FIG. 1.

FIG. 26 is a first end view of the cam used for the sash lock of FIG. 1.

FIG. 27 is a second end view of the cam used for the sash lock of FIG. 1.

FIG. 28 is a first perspective view of the lever member used for the sash lock of FIG. 1.

FIG. 29 is a second perspective view of the lever member used for the sash lock of FIG. 1.

FIG. 30 is a front view of the lever member used for the sash lock of FIG. 1.

FIG. 31 is a top view of the lever member used for the sash lock of FIG. 1.

FIG. 32 is a bottom view of the fever member used for the sash lock of FIG. 1.

FIG. 33 is a first end view of the lever member used for the sash lock of FIG. 1.

FIG. 34 is a second end view of the lever member used for the sash lock of FIG. 1.

FIG. 35 is a rear view of the lever member used for the sash lock of FIG. 1.

FIG. 36 is a first perspective view of the plate member used for the sash lock of FIG. 1.

FIG. 37 is a second perspective view of the plate member used for the sash lock of FIG. 1.

FIG. 38 is a third perspective view of the plate member used for the sash lock of FIG. 1.

FIG. 39 is a fourth perspective view of the plate member used for the sash lock of FIG. 1.

FIG. 40 is a front view of the plate member used for the sash lock of FIG. 1.

FIG. 41 is a top view of the plate member used for the sash lock of FIG. 1.

FIG. 42 is a bottom view of the plate member used for the sash lock of FIG. 1.

FIG. 43 is a first end view of the plate member used for the sash lock of FIG. 1,

FIG. 44 is a second end view of the plate member used for the sash lock of FIG. 1.

FIG. 45 is a rear view of the plate member used for the sash lock of FIG. 1.

FIG. 46 is a perspective view of the compression spring used for the sash lock of FIG. 1.

FIG. 47 is a perspective view illustrating the compression spring of FIG. 46 received upon a post of the plate member of FIG. 37.

FIG. 48 illustrates the bottom view of the housing shown in FIG. 12, just prior to receiving the assembled compression spring and plate member of FIG. 47 therein.

FIG. 49 illustrates the bottom view of the housing shown in FIG. 48, just after receiving the assembled compression spring and plate member therein.

FIG. 50 is a perspective view illustrating the housing with the assembled compression spring and plate member received therein.

FIG. 51 is the bottom view of FIG. 48, but which also shows the shaft received within an orifice of the housing.

FIG. 52 is a perspective view showing the housing with the assembled compression spring and plate member received therein, and the shaft received within the orifice of the housing, as shown in FIG. 51.

FIG. 53 is the bottom view of FIG. 51, but which also shows the cam received onto the shaft within the housing cavity.

FIG. 54 is a perspective view of the housing with the assembled compression spring and plate member received therein, and the shaft received within the orifice of the housing, with the cam pivotally mounted thereto, as shown in FIG. 53.

FIG. 55 is the bottom view of FIG. 54, but which also shows the plate member fixedly secured to the shaft within the housing cavity.

FIG. 56 is a top perspective view of the lock assembly, shown with the top portion cut away to expose the curved surface of the plate member engaged within the first curved recess of the shaft.

FIG. 57 is the top perspective view of the lock assembly, as shown in FIG. 56, but is shown with the top portion cut away further to expose the protrusion of the plate member engaged within the first shaped opening of the shaft, with the cam shown in the extended lock position.

FIG. 58 is a bottom perspective view of the lock assembly shown with the bottom portion cutaway to expose the protrusion of the plate member engaged within the first shaped opening of the shaft, with the cam shown in the extended lock position.

FIG. 59 is the top perspective view of the lock assembly, but is shown with one-quarter of the lock assembly cutaway to expose the protrusion of the plate member engaged within the first shaped opening of the shaft, with the cam shown in the extended lock position.

FIG. 60 is the bottom view of the sash lock, as shown in FIG. 55, but is also shown with an arrow indicating application of an actuation force applied to the handle, and a second arrow indicating an initial direction of movement of the exposed portion of the cam.

FIG. 61 is a perspective view of the sash lock, as shown in FIG. 60.

FIG. 62 is the top perspective view of FIG. 56, but is shown with the handle having been rotated for the curved surface of the plate member having just been rotated sufficiently to be disengaged from the first curved recess of the shaft.

FIG. 63 is the top perspective view of the lock assembly, as shown in FIG. 62, but is shown with the top portion cut away further to expose the protrusion of the plate member disengaged from the first shaped opening of the shaft.

FIG. 64 is the cut-away bottom perspective view of FIG. 58, but is shown with the handle having been rotated as for FIG. 62, for the curved surface of the plate member to be disengaged from the first curved recess of the shaft.

FIG. 65 is the top perspective view of the lock assembly, with the shaft and handle as positioned as in FIG. 62 and FIG. 63, but is shown with one-quarter of the lock assembly cutaway to expose the protrusion of the plate member engaged within the first shaped opening of the shaft.

FIG. 66 is the bottom view of FIG. 60, but is shown with the shaft and handle rotated roughly 50 degrees, with corresponding rotation of the plate member, for the protrusion of the plate member to initially contact a first end of an arcuate recess in the cam, to begin to drive the cam to co-rotate in a first direction, to begin retraction of the cam into the housing cavity towards the retracted cam position.

FIG. 67 is a bottom perspective view of the sash lock, with the shaft and handle shown positioned the same as in FIG. 66.

FIG. 68 is the cutaway top perspective view of FIG. 62, but is shown with the handle having been rotated roughly 140 degrees for the curved surface of the plate member to become engaged with the second curved recess of the shaft, with the cam then positioned in the unlocked (retracted) position.

FIG. 69 is the cutaway top perspective view of FIG. 63, but is shown with the handle having been rotated roughly 140 degrees for the protrusion of the plate member to become engaged with the second shaped opening of the shaft, with the earn positioned in the unlocked (retracted) position.

FIG. 70 is the cutaway bottom perspective view of FIG. 64, but is shown with the handle having been rotated roughly 140 degrees for the protrusion of the plate member to become engaged with the second shaped opening of the shaft with the cam positioned in the unlocked (retracted) position.

FIG. 71 is the cutaway bottom perspective view of FIG. 59, but is shown with the handle having been rotated roughly 140 degrees for the curved surface of the plate member to become engaged with the second curved recess of the shaft, with the cam then positioned in the unlocked (retracted) position.

FIG. 72 is the bottom view of FIG. 60, but is shown with the handle having been rotated roughly 140 degrees for the curved surface of the plate member to become engaged with the second, curved recess of the shaft, with the cam then positioned in the retracted unlock position.

FIG. 73 is a bottom perspective view of the sash lock, with the shaft and handle shown positioned the same as in FIG. 72.

FIG. 74 is the cutaway top perspective view of FIG. 68, but is shown with the handle having been counter-rotated roughly 50 degrees for the curved surface of the plate member to become disengaged from the second curved recess of the shaft, with the cam still positioned in the retracted unlock position.

FIG. 75 is the cutaway top perspective view of FIG. 69, but is shown with the handle having been counter-rotated roughly 50 degrees for the protrusion of the plate member to become disengaged from the second shaped opening of the shaft, with the cam still positioned in the retracted unlock position.

FIG. 76 is the cutaway bottom perspective view of FIG. 70, but is shown with the handle having been counter-rotated roughly 50 degrees for the protrusion of the plate member to become disengaged from the second shaped opening of the shaft, with the cam still positioned in the retracted unlock position.

FIG. 77 is the cutaway bottom perspective view of FIG. 71, but is shown with the handle having been counter-rotated roughly 50 degrees for the protrusion of the plate member to become disengaged from the second shaped opening of the shaft, with the cam still positioned in the retracted unlock position.

FIG. 78 is the bottom view of FIG. 72, but is shown with the handle having been counter-rotated roughly 50 degrees, for the protrusion of the plate member to initially contact a second end of the arcuate recess in the cam, to begin to drive the cam to co-rotate in a second direction, to begin extending the cam out from the housing cavity towards the locked (extended) position.

FIG. 79 is a bottom perspective view of the sash lock, with the shaft and handle shown positioned the same as in FIG. 78.

### DETAILED DESCRIPTION OF THE INVENTION

As used throughout this specification, the word “may” is used in a permissive, sense (i.e., meaning having the potential to), rather than the mandatory sense (i.e., meaning must). Similarly, the words “include”, “including”, and “includes” mean including but not limited to.

The phrases “at least one”, “one or more”, and “and/or” are open-ended expressions that are both conjunctive and disjunctive in operation. For example, each of the expressions “at least one of A, B and C” “one or more of A, B, and C”, and “A, B, and/or C”mean all of the following possible combinations: A alone; or B alone; or C alone; or A and B together; or A and C together: or B and C together; or A, B and C together.

Also, all references (e.g., patents, published patent applications, and non-patent literature) that are cited within this document are incorporated, herein in their entirety by reference.

Furthermore, the described features, advantages, and characteristics of any particular embodiment disclosed herein, may be combined in any suitable manner with any of the other embodiments disclosed herein.

It is further noted that any use herein of relative terms such as “top,” “bottom,” “upper,” “lower,” “vertical,” and “horizontal” are merely intended to be descriptive for the reader, based on the depiction of those features within the figures for one particular position of the lock on one particular window, and such terms are not intended to limit the orientation with which the device of the present invention may be utilized, not the type of fenestration products upon which it may be used.

The tamper-resistant lock 101 may be used to secure many different fenestration products with members that may move with respect to another. For example, the lock 101 may be used to secure one or more sashes of a sash window assembly, the sash window assembly having a lower sash window formed with a meeting rail, a bottom rail, and a pair of stiles, being slidably disposed in a master window frame, and an upper sash window that may have a keeper.

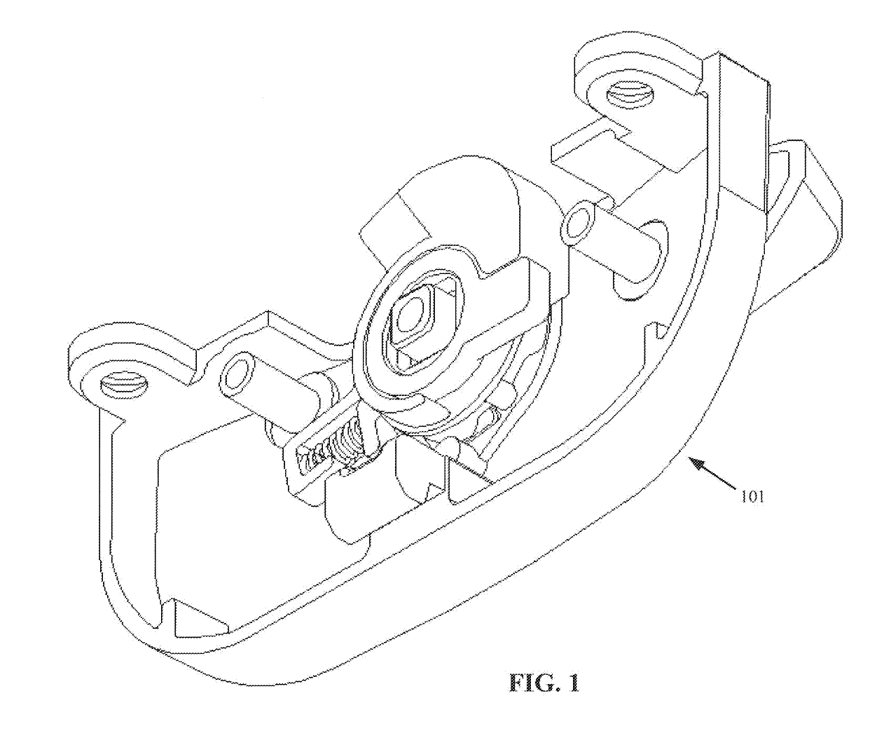

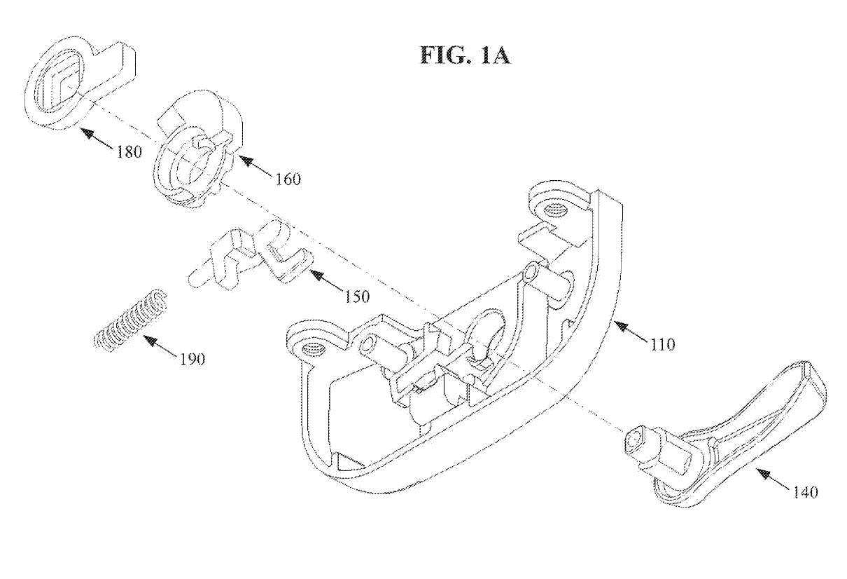

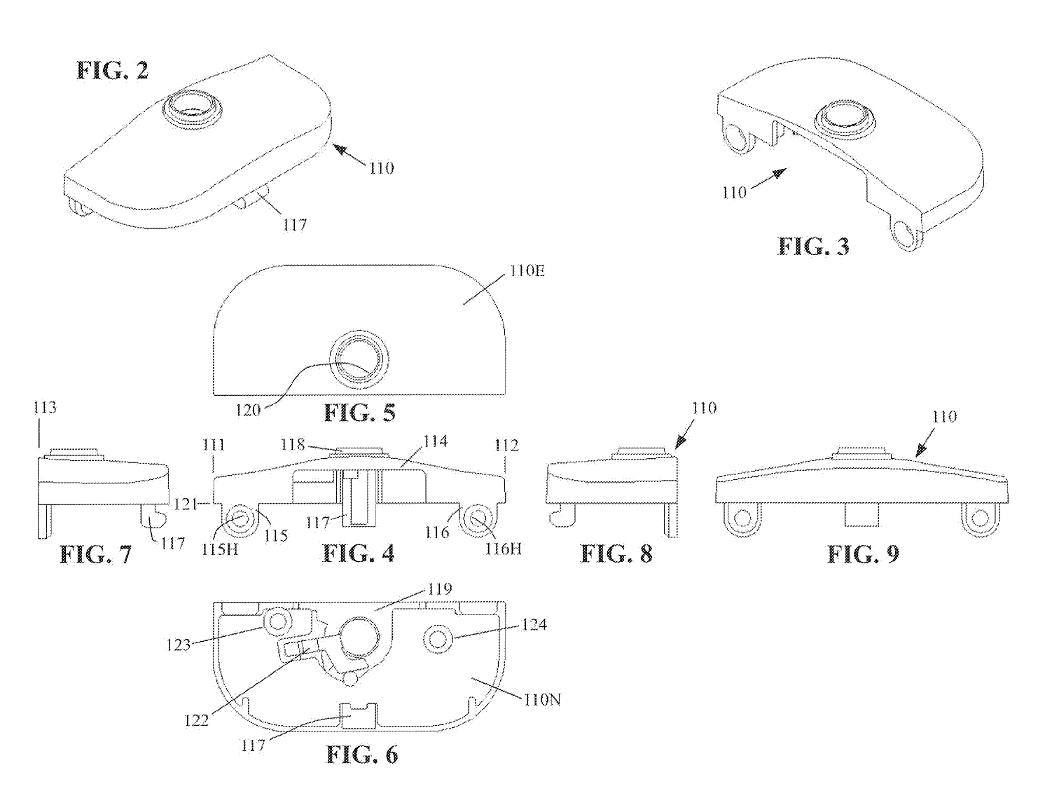

In accordance with at least one embodiment of the present invention, a tamper-resistant lock 101 may broadly include a housing 110, a shaft/handle member 140, a plate member 150, a cam 160, a lever member 180, and a spring 190, which may be a compression spring. One embodiment of these parts that may be used for the lock 101 is shown in an exploded view in FIG. 1A, and are also shown assembled in the perspective view of FIG. 1.

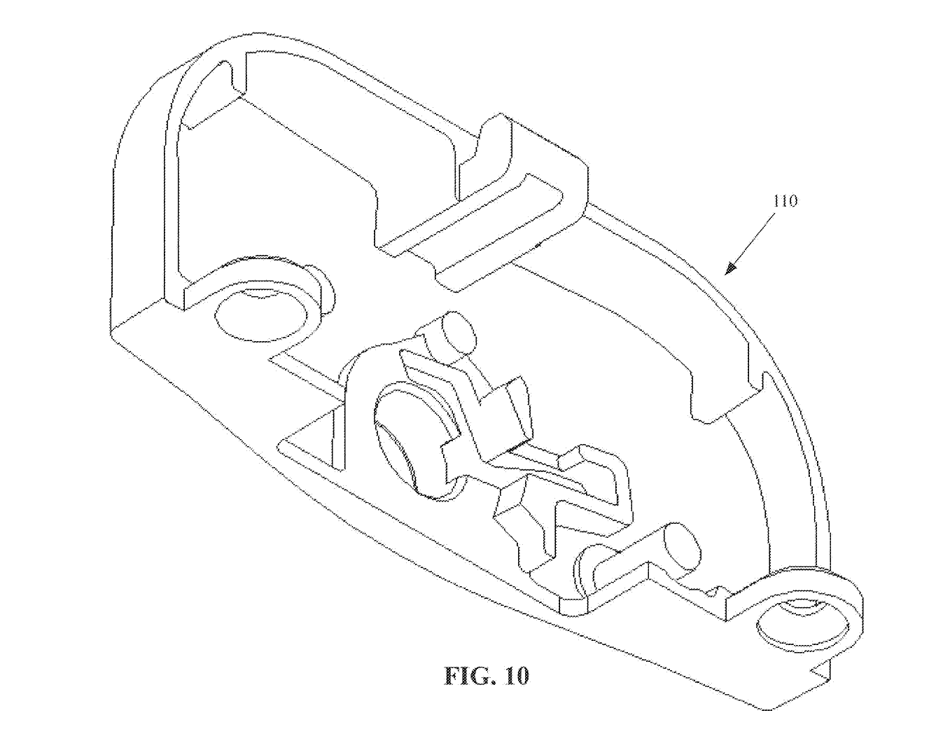

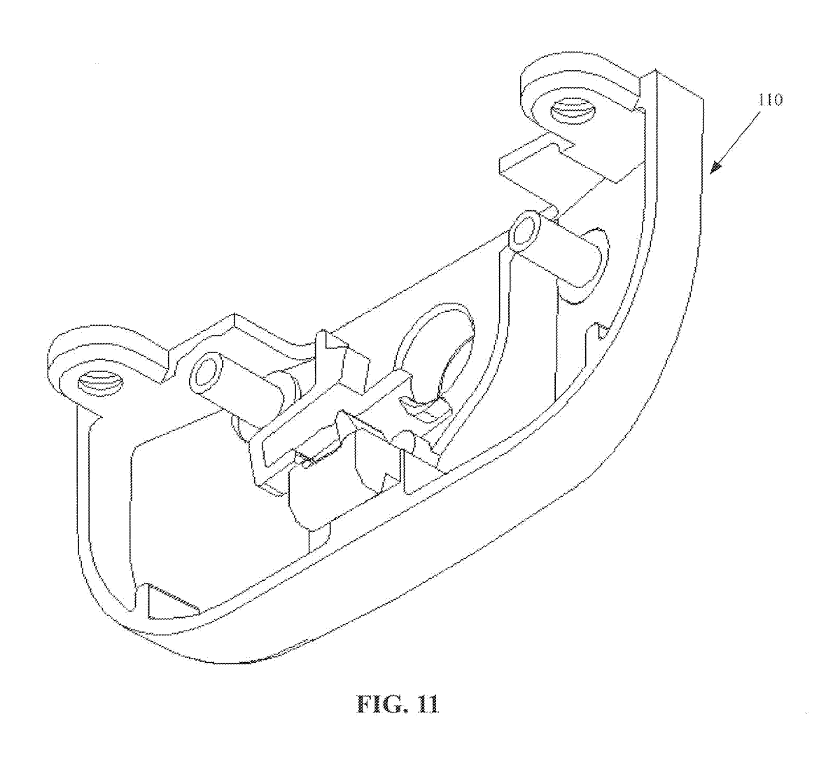

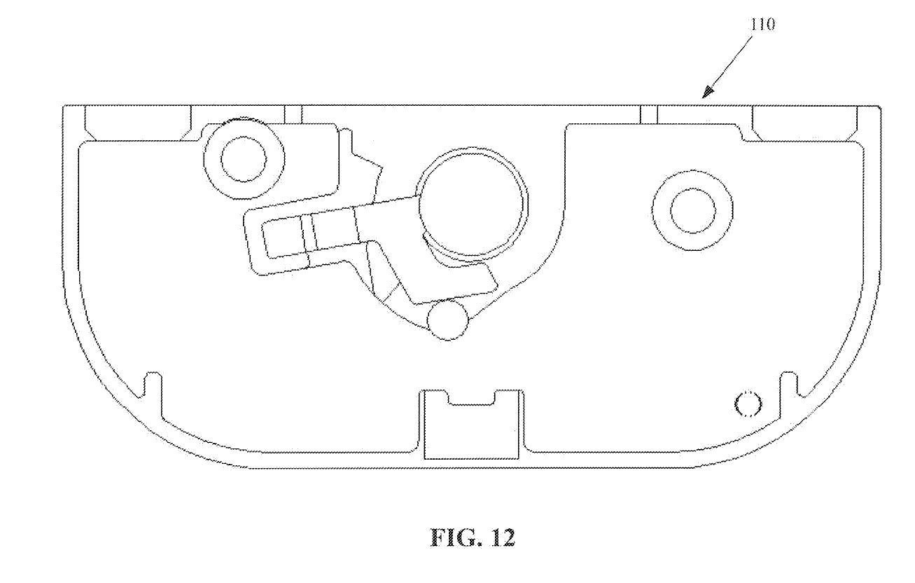

Perspective views of the housing 110 are shown in FIGS, 2-3 and FIGS. 10-11, while corresponding orthogonal views are shown in FIGS. 4-9. The housing 110 is not limited to the shape illustrated within those figures and could take on many different suitable shapes, including a rectangular shape, an irregular shape, etc. However, the housing 110 may desirably be formed of at least one wall that may be shaped to form an exterior surface 110E, and an interior surface 110N that defines a cavity, and which, wall may terminate in a generally flat bottom 121 that may be configured to rest upon the top of the meeting rail. The housing wall may span from a first end 111 to second end 112. The bottom 121 may be open as shown, or the wall may extend over only a portion of the bottom of the housing. The housing wall may also be shaped to form a generally flat surface 113, which may have an opening 114 that interconnects with the cavity of the housing. The wall of housing 110 may extend beyond the bottom 121 to form a first protrusion 115 and a second protrusion 116, each of which may have a respective mounting hole 115H/116H formed therein for receiving a fastener for securing the sash lock 101 to the meeting rail of the sliding sash window. A leg 117 may extend from an opposite side of the housing 110, which may be received within an opening in the meeting rail, to be used in combination with the mounting holes 105H/106H for securing the sash lock 101 to the meeting rail. An orifice may also be formed in a top portion of the housing 110 which may also be interconnected with the cavity.

Extending away from the interior surface 110N of the housing 110 may be at least one cylindrical protrusion that may extend to terminate on a planar extension of the fiat surface 111, and may be used to support a central portion of the wall. In one embodiment, two such protrusions 123/124 may be utilized, each of which may be hollow.

The housing 111 may have a cylindrical boss 18 extending upwardly from the outer surface 110E, and may also have a boss (or thickened area) 119 extending downwardly from the interior surface 110N, into the housing cavity. The housing 110 may have, a hole 120 through the boss 118 and boss 119, which may be used for pivotal mounting of the shaft/handle member 140 to the housing. A shaped recess 122 may be formed in the interior of the housing wall in the area 119 of the wall, a portion of which may be elongated.

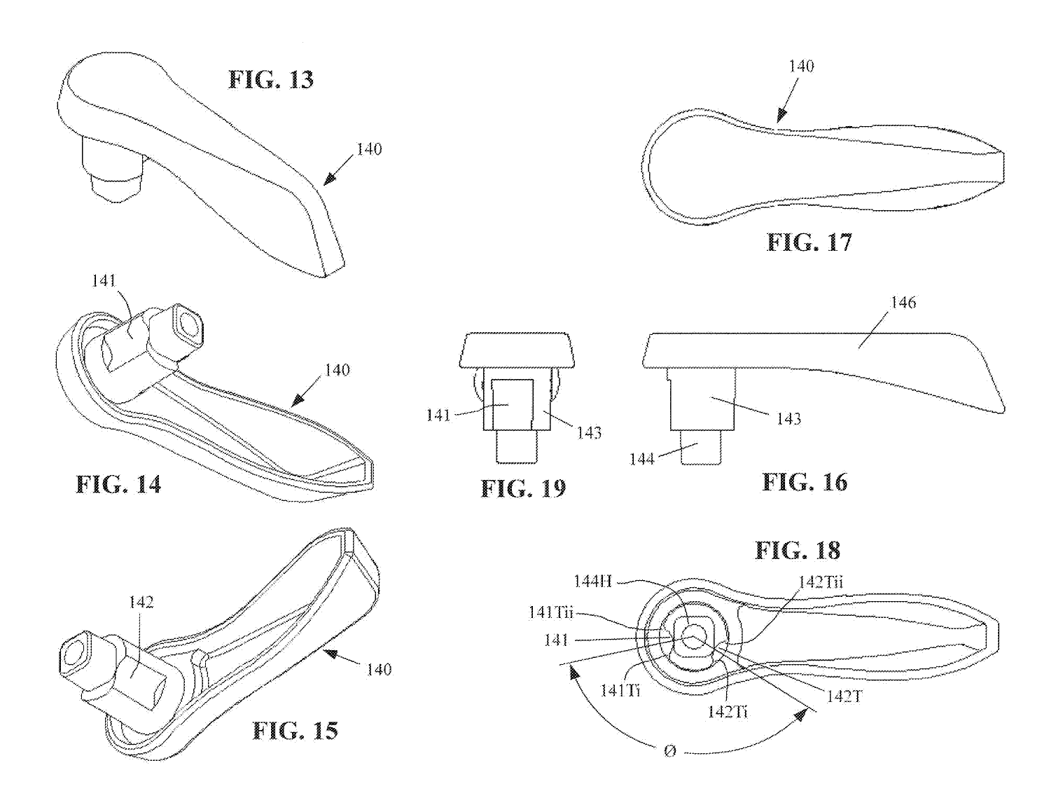

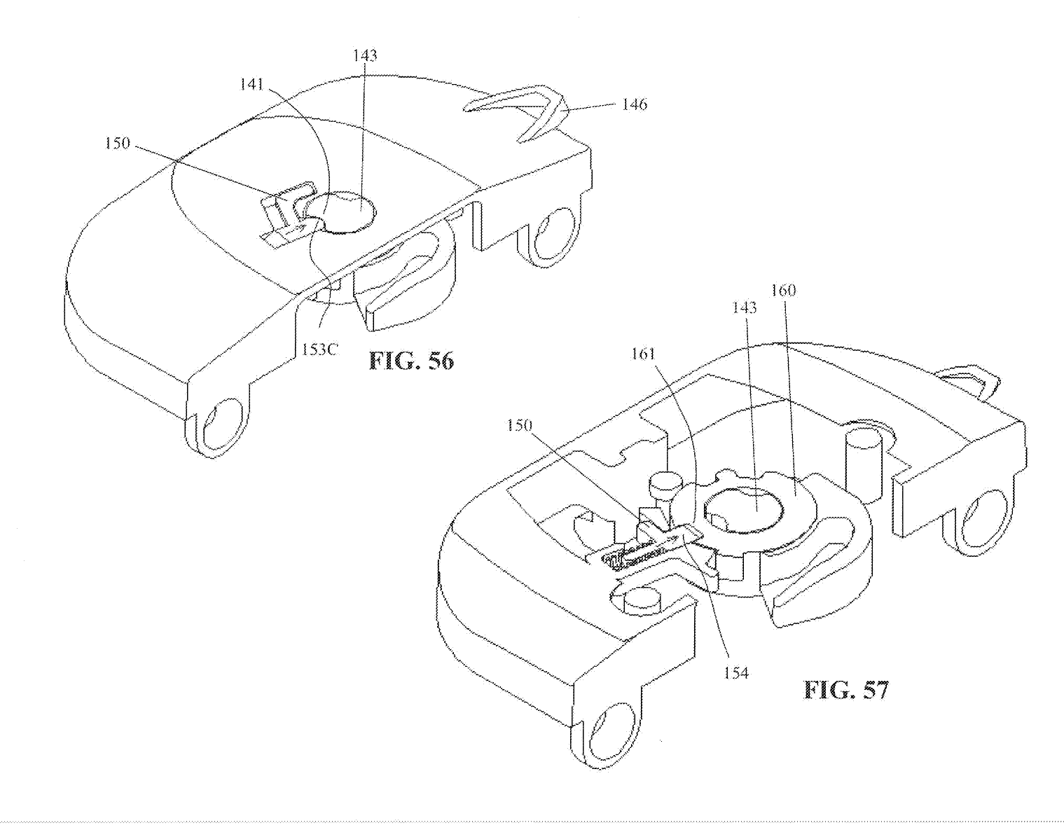

As seen in FIGS. 13-19, a shaft/handle member 140 may have a cylindrical shaft 143, one end of which may have a rectangular-shaped protrusion 144 with a hole 144H formed therein, which may receive a rivet or other fastener, for mounting of the lever member 180 thereto. The other end of the shaft 143 may have a knob or other enlarged circular cross-sectional shape to permit that end of the shaft to be easily grasped by the user. In one embodiment, the other end of the shaft 143 may have a graspable handle portion 146 that may extend generally orthogonally with respect to the axis of shaft 143. The shaft 143 may be configured to be pivotally received within the hole 120 in the boss 118 of the housing 110. The shaft 143 may have a first recess 141 that may be formed to extend substantially parallel to the axis of the cylindrical shaft. The recess 141 may be formed of a portion of a cylindrical surface, or may be formed by another curved surface. The curved recess 141 may transition to the cylindrical surface of the shaft 143 using a first curved transition surface 141Ti and a second transition surface 141Tii (FIG. 18). A second recess 142 may be similarly formed, and may similarly transition to the cylindrical surface of the shaft 143 using a first curved transition surface 142Ti and a second transition surface 142Tii. The first recess 141 and the second recess 142 may be clocked on the shaft 143, as shown in FIG. 18, to be particularly oriented for latching of the cam 160 to make the lock 101 tamper-proof, which clocking angle Θ is discussed further hereinafter. In one embodiment, the first recess 141 and the second recess 142 may be clocked 140 degrees apart from each other (i.e., Θ=140°), to permit the handle to be rotated that same amount in moving the cam from the locked (extended) position to an unlocked (retracted) position. Note that in another embodiment, a different angular clocking may be used (e.g., 180 degrees). The first recess 141 may also be clocked on the shaft 143 so that the handle 160 may be oriented as shown in FIG. 56, when the cam 160 is in the locked (extended) cam position.

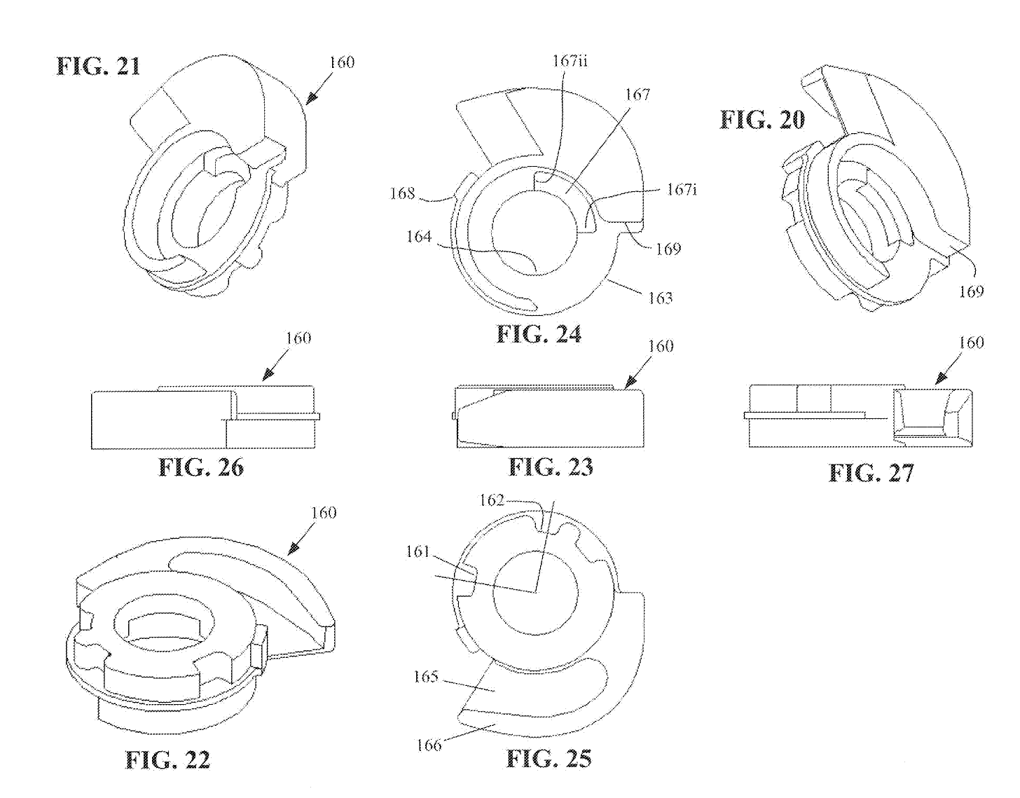

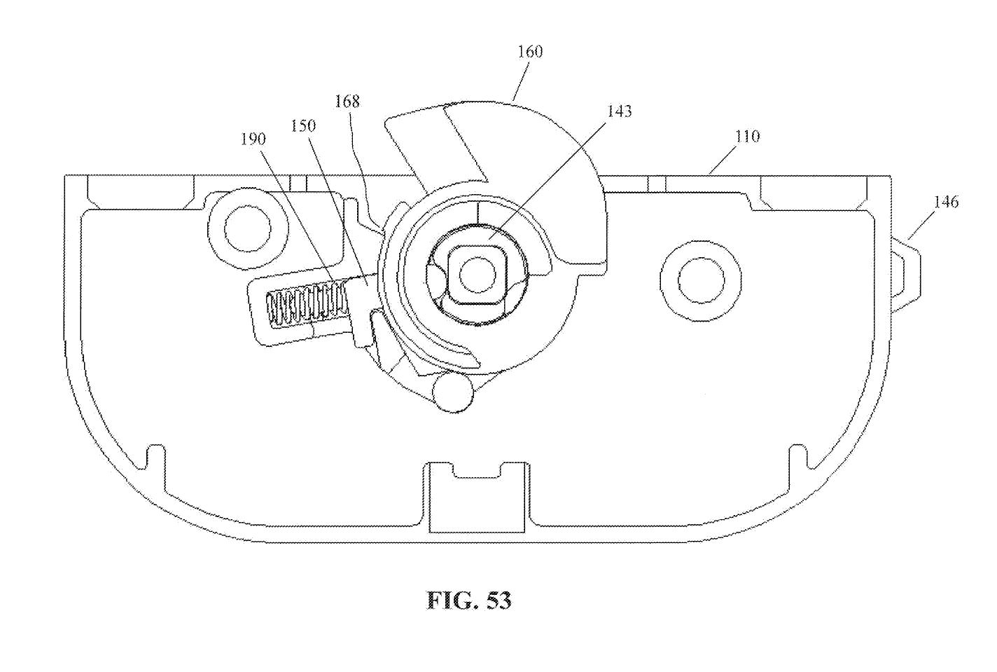

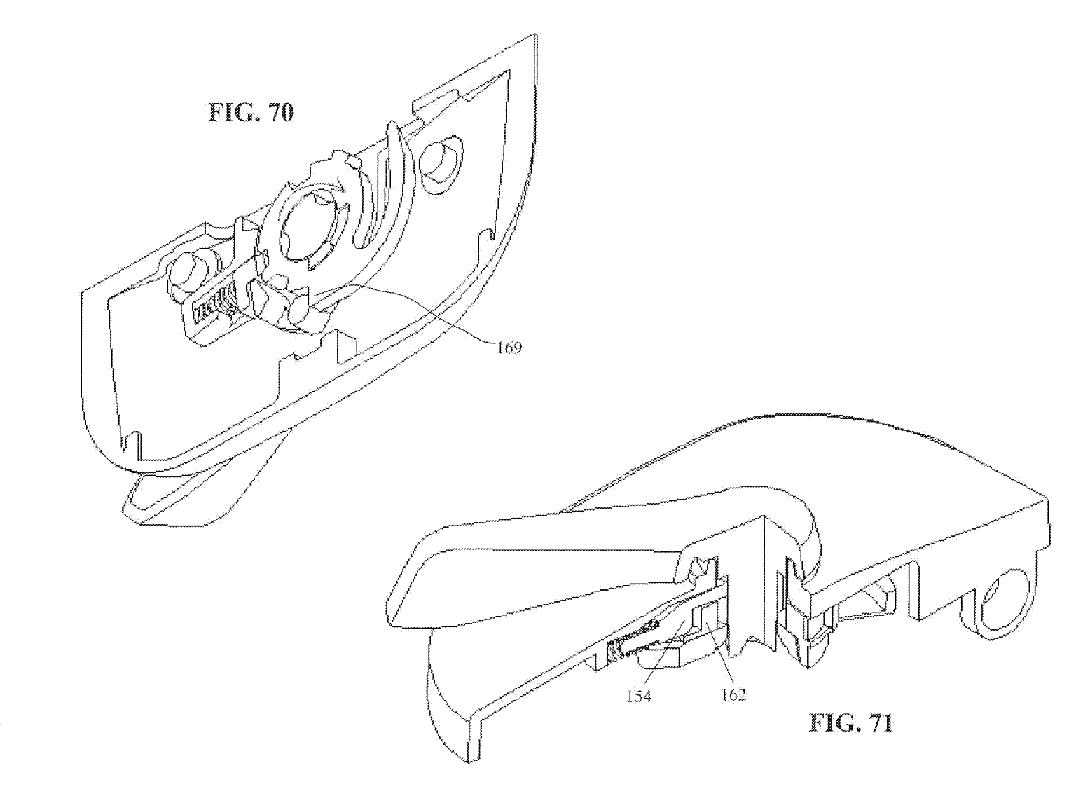

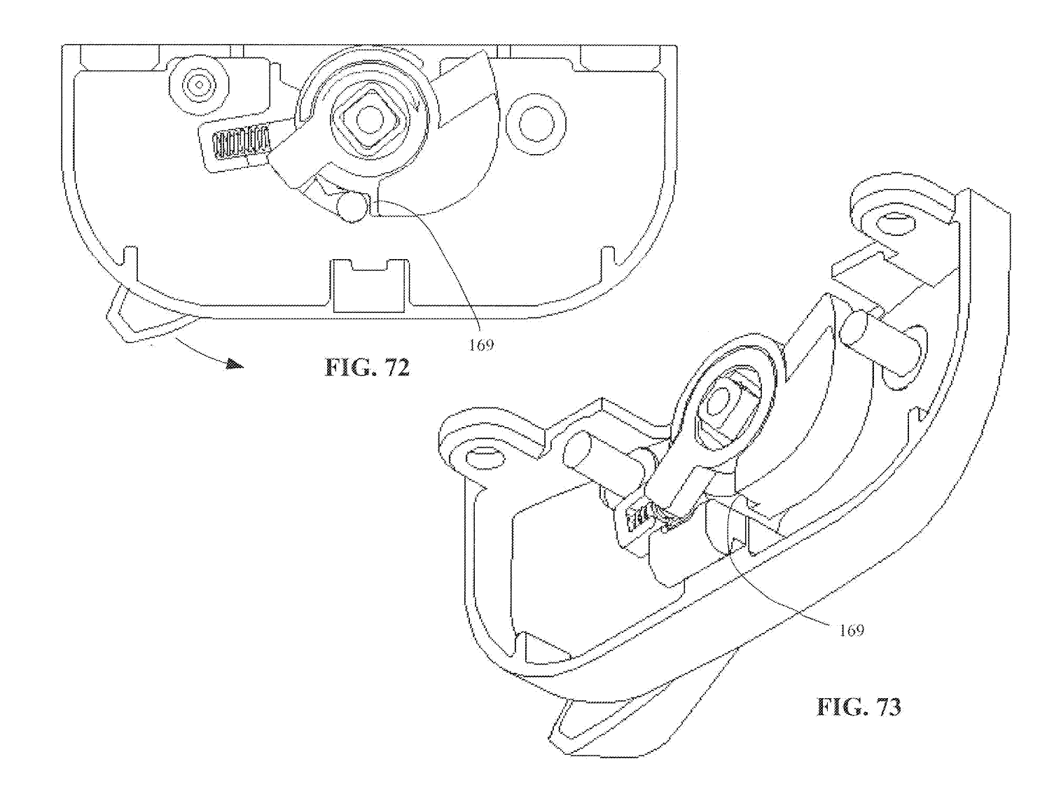

The locking cam 160, illustrated in FIGS. 20-27, may have a cylindrical hub 163, with a hole 164 formed therein that is sized to permit the cam to thereby be pivotally mounted to the shaft/handle member 140. Extending laterally away from the hub 165 may be a wall 165, and extending laterally away from the wall 165 may be a curved cam wall 166, which may be used to engage a key of the corresponding keeper, and to draw the sliding sash window in closer proximity to the master window frame (or to the other sash window for a double-hung arrangement). The hub 163 of the cam 160 may have a first shaped opening 161 and a second shaped opening 162 formed at first and second respective positions on the hub. The first shaped opening 161 may be formed thereon relative to the wall 166 to be clocked so that it may be properly engaged, as discussed hereinafter, when the cam 160 is in the locked (extended) cam position (e.g., FIG. 57). The second shaped opening 162 may be clocked relative to the first shaped opening 161 so that it may be properly engaged, as discussed hereinafter, when the cam 160 is in the unlocked (retracted) cam position (e.g., FIG. 69). The clocking between the first shaped opening 161 and the second, shaped, opening 162 may depend upon the unconnected movement between the shaft 140 and the cam 160 (i.e., when they do not co-rotate). In one embodiment, the first shaped opening 161 and the second shaped opening 162 may be clocked to be 90 degrees apart, which, for the 140 degree clocking of the first recess 141 and the second recess 142 of the shaft/handle member 140, may result in 50 degrees of unconnected movement between the shaft 140 and the cam 160, as discussed further hereinafter. A recess 167, which may be annular, may be formed in the hub 163, having a first end 167i, and a second end 167ii The ends 167s and 167ii of the recess 167 may also be clocked to be 90 degrees apart, as those ends may provide an engagement surface by which the cam 160 may be driven by the lever member 180. A protruding feature (e.g., protrusion 168) may be formed on the hub 163 to engage a corresponding feature on the housing 110 to serve as a stop, to limit, outward pivotal travel, of the cam 160 at the locked (extended) cam position (FIG. 53). Another protruding feature (e.g., protrusion 169) may be formed on the hub 163 to engage a corresponding feature on the housing 110 to serve as another stop, and may limit pivotal travel, of the earn 160 into the housing cavity to be at the unlocked (retracted) cam position (FIG. 70).

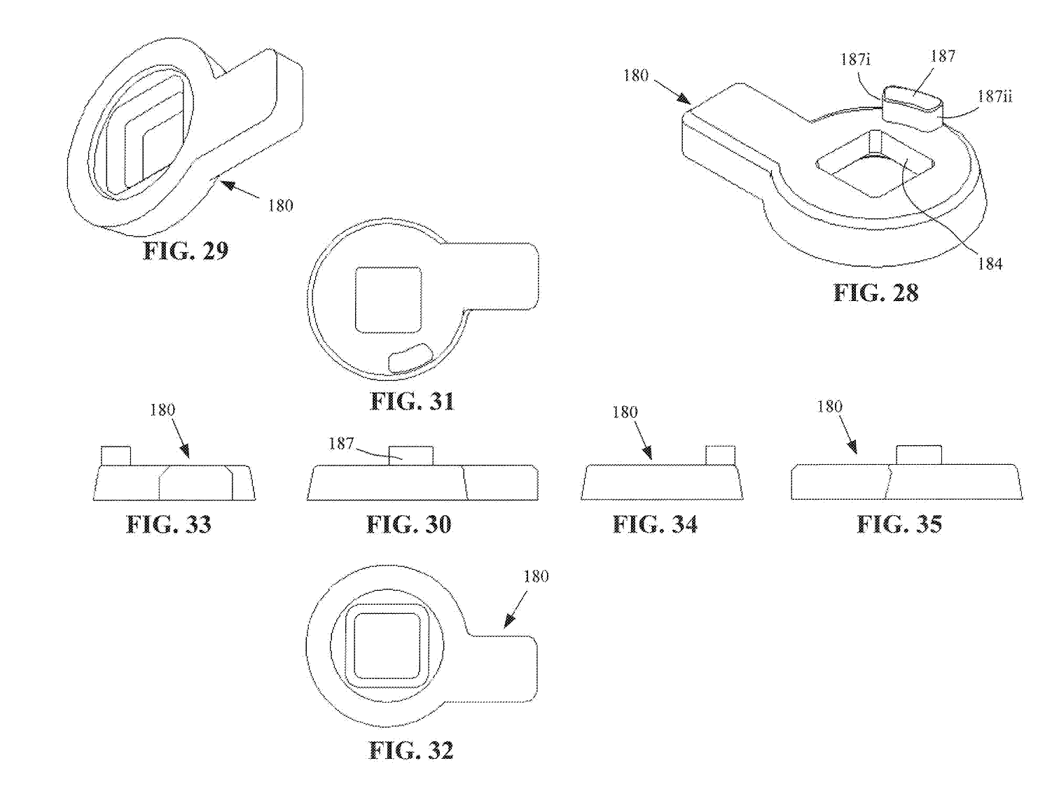

The lever member 180, illustrated in FIGS. 28-35, may be configured to be secured to the rectangular shaped protrusion 144 at the end of the shaft 143, in any suitable manner (e.g., using one or a plurality of mechanical fasteners). In one embodiment the lever member may be formed as a flat plate with a rectangular shaped recess 184 that may be sized to be received upon the rectangular shaped protrusion of the 144 at the end of the shaft 143. Instead of the rectangular through-opening shown in FIG. 31, a hole (not shown) may be formed in the lever member 180 for receiving a mechanical fastener (e.g., a rivet, a screw, etc.) therethrough, and into the hole 144H of the shaft/handle member 140, for securing the lever member to the shaft. The Sever member 180 may also be formed with a protrusion 187 that may have a first side 187i and a second side 187ii that are respectively configured to alternately engage each of the first end 167i and the second end 167ii of the arcuate recess 167 of the cam 160, to be able to drive the cam in each of a first and a second direction, between the unlocked (retracted) cam position and the locked (extended) cam position.

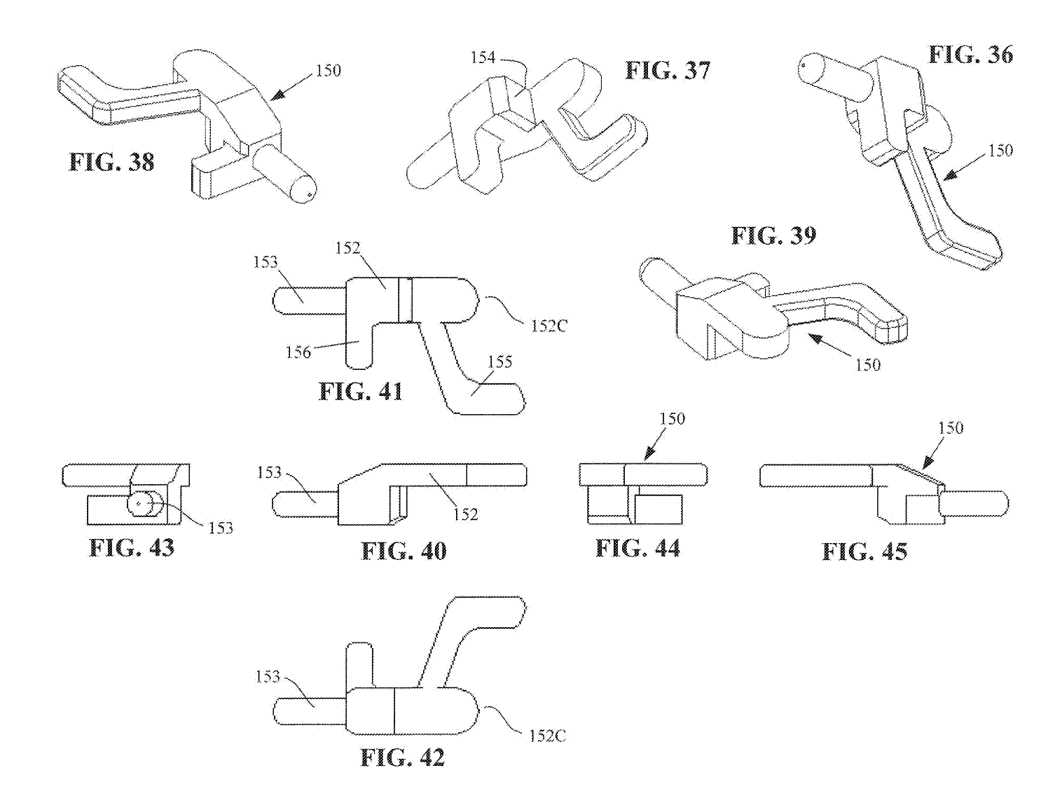

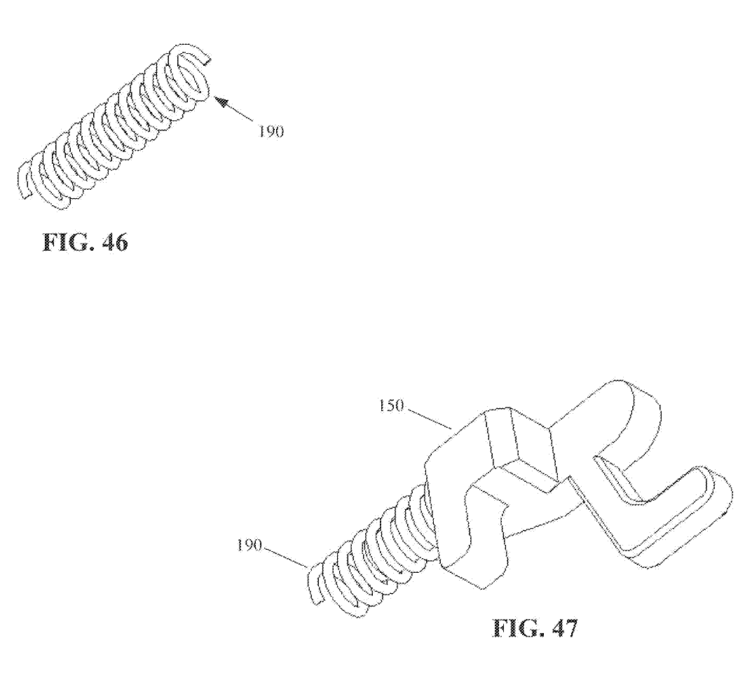

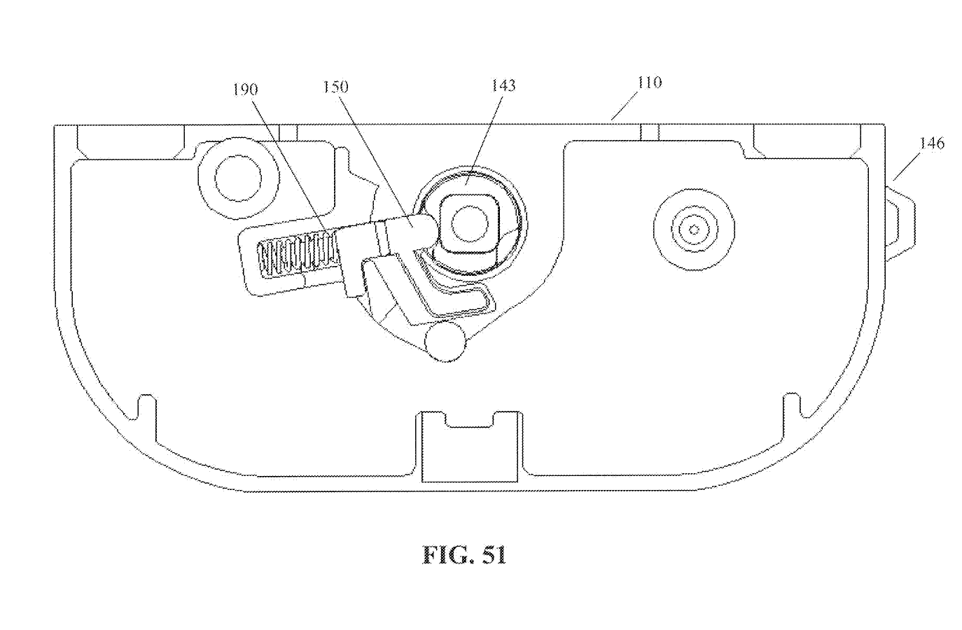

The plate member 150, illustrated in FIGS. 36-45, may be formed with a first portion 152 that may be configured to be slidably received within the elongated recess 122 of the housing 110. A corresponding cross-sectional shape may be used for each of the first portion 152 and the recess 122, which may be a circular cross-section, or a square cross-section, etc. A free end of the first portion 152 of the plate member may be formed into a curved surface 152C. The curved surface 152C may be shaped to correspond to the shape of the first and second curved recesses 141/142 of the shaft/handle member 140. The plate member 150 may also be formed with a second portion 153 that may be configured to extend from the first portion of the plate member, and may be configured to slidably receive the helical compression spring 190 thereon (FIG. 47), which may be used to bias the curved surface 152C of the plate member 150 into contact with the shaft 140 (see e.g., FIG. 51). The plate member 150 may also be formed with a protrusion 154 that may be shaped to be received within each of the first shaped opening 161 of the cam 160, and the second shaped opening 162 of the cam, both of which may be formed with the same shape. The plate member 150 may also be formed with a shaped protrusion 155 that may be received within a correspondingly shaped recessed portion in the housing, which may serve in guiding the movement of the plate member towards the shaft/handle member 140, in addition to, or as an alternative to, the first portion 152 and the recess 122. The plate member 150 may also be formed with a protrusion 156 that may co-act with a feature on the housing 110 to serve as a stop to limit the biased movement of the plate member towards the shaft/handle member 140.

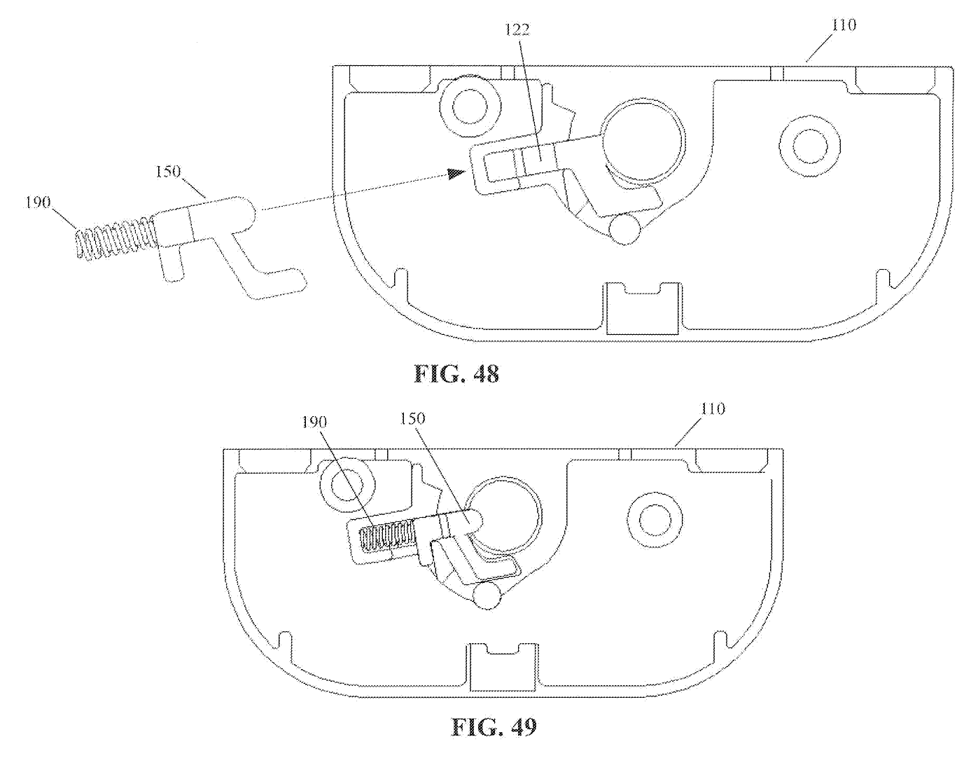

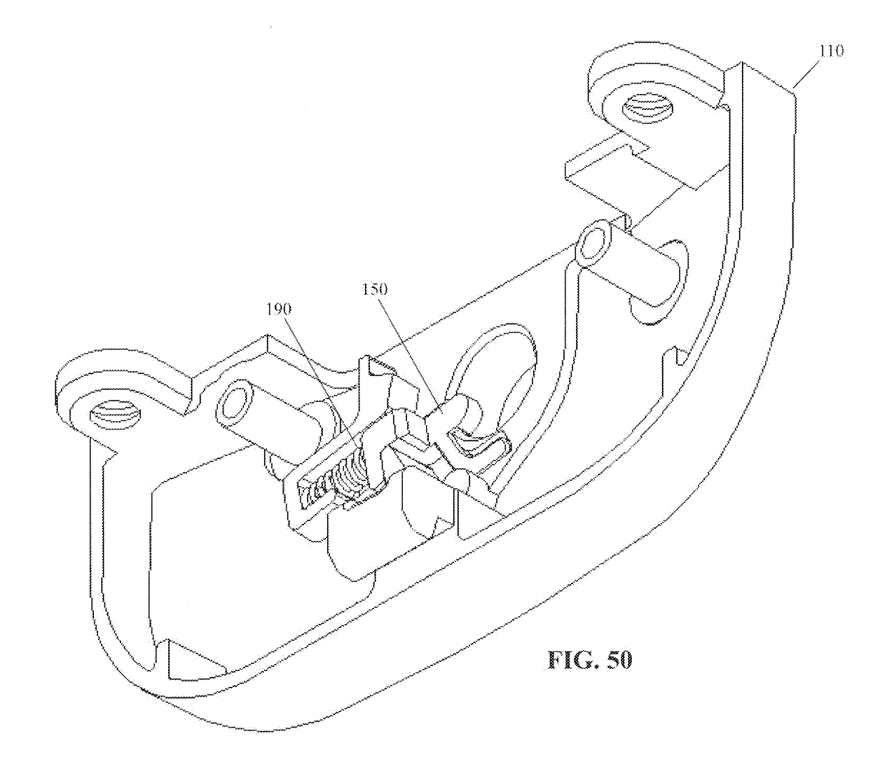

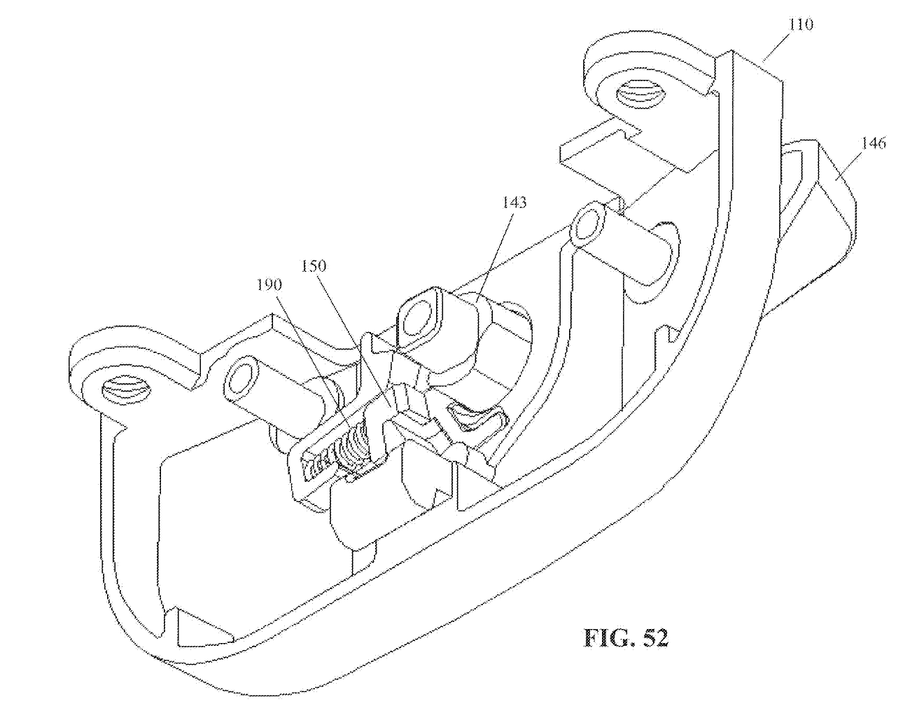

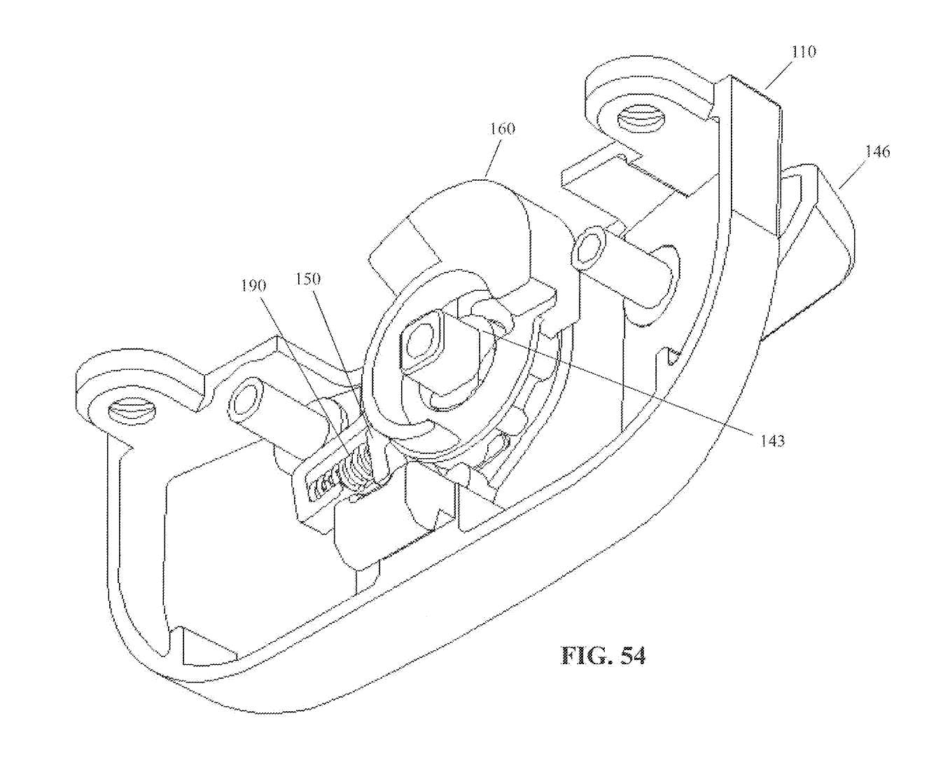

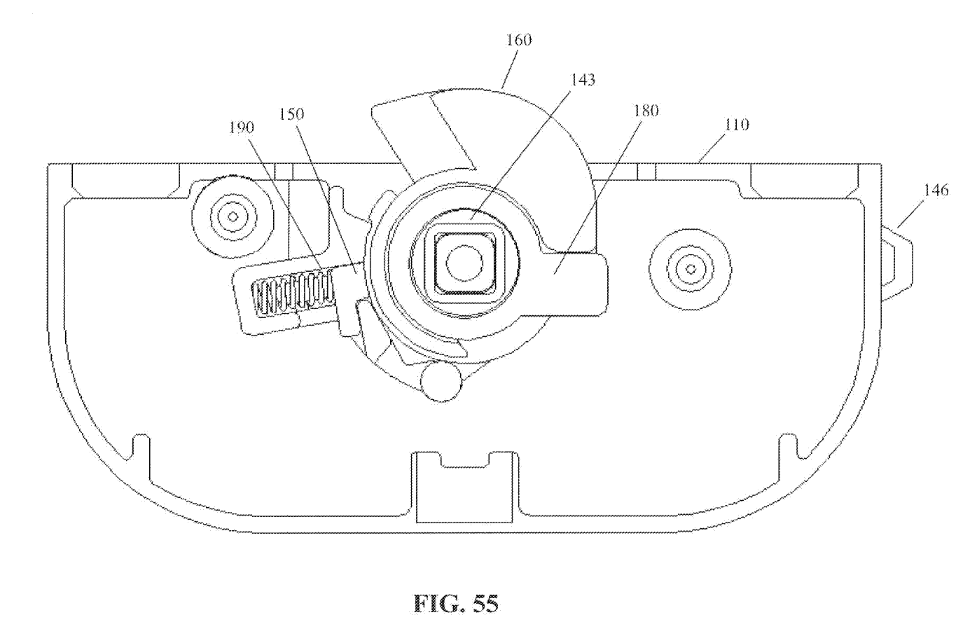

Assembly of the component parts shown in the exploded view of FIG. 1A is shown sequentially within FIGS. 47-55. In FIG. 47, the spring 190 is shown received onto the second portion 153 of plate member 150. In FIG. 48, the plate member 150 with the spring 190 received on its second portion 153 may be inserted into the recess 122 of the housing 110, to be as shown in FIG. 49 and FIG. 50. Next the cylindrical shaft 143 of the shaft/handle member 140 may be received into the hole 120 of housing 110, and may be clocked as shown in FIG. 51 and FIG. 52, which may result in the curved surface 152C of the plate member 150 being received within the recess 141 of the shaft/handle member 140. As shown within FIG. 53 and FIG. 54, the cam 160 may then be pivotally mounted to the shaft/handle member 140, with the hole 164 of the cam being received upon the shaft 143 of the shaft/handle member. The lever member 180 may then be fixedly secured to the shaft/handle member 140, with the rectangular shaped recess 184 of the lever member being received upon, the rectangular -shaped protrusion 144 of a shaft/handle member, as shown in FIG. 55. The lever member 180 may be fixedly secured thereto using any attachment means known in the art, including, but no limited to, adhesive, mechanical fasteners, etc.

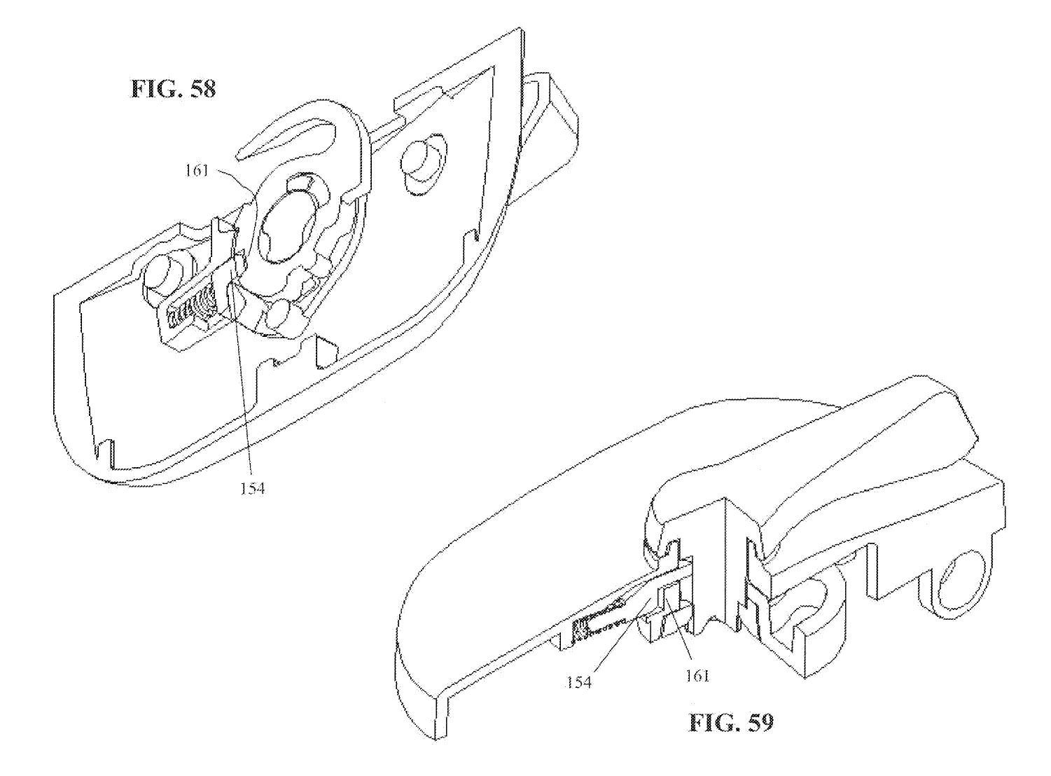

Being so assembled, the earn 160 is configured to be rotated, through rotation of the shaft/handle member 140, in a first direction out of the housing opening 144 into an extended position for the walls 165/166 to engage the keeper to lock the sash window(s) in the locked cam position, and may be seen in FIGS. 57-61.

As seen therein, with the cam 160 in the locked (extended) position, the compression spring 190 biases the plate member 150 for its curved surface 153C to be aligned and engaged with the first recess 141 of the shall 143 of the shaft/handle member 140 (FIG. 56), and for protrusion 154 of the plate member 150 to be to be received within the first shaped opening 161 of the earn 160 (FIG. 57).

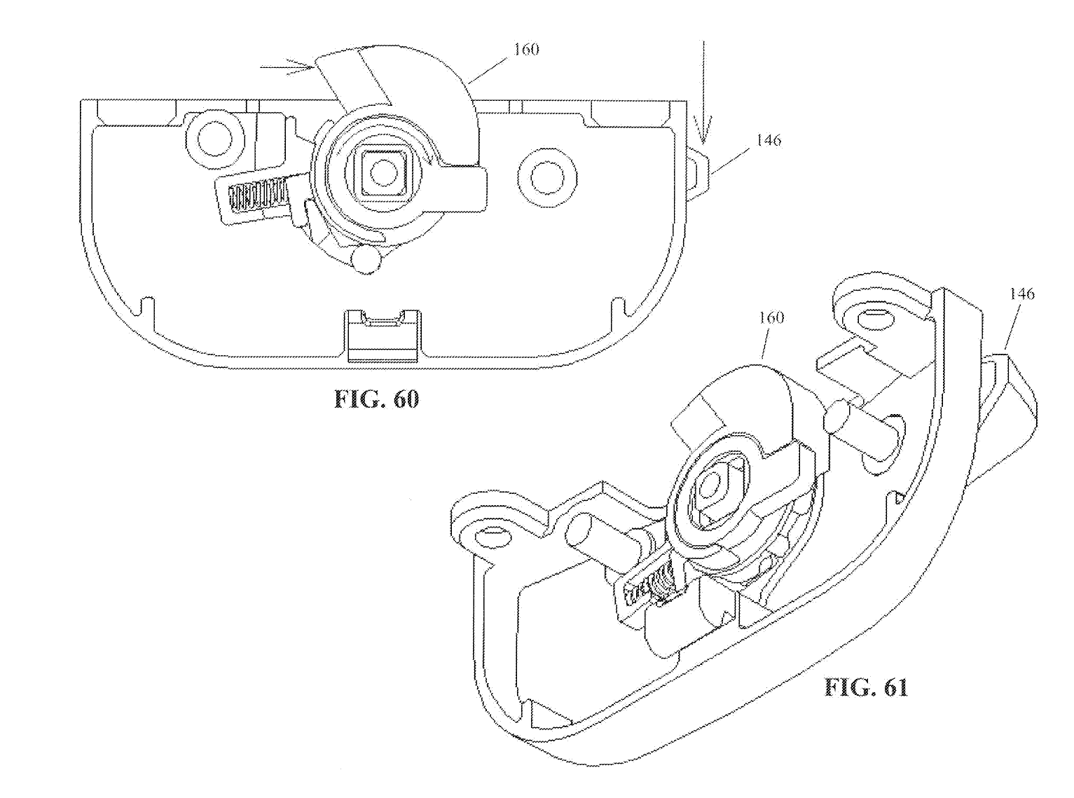

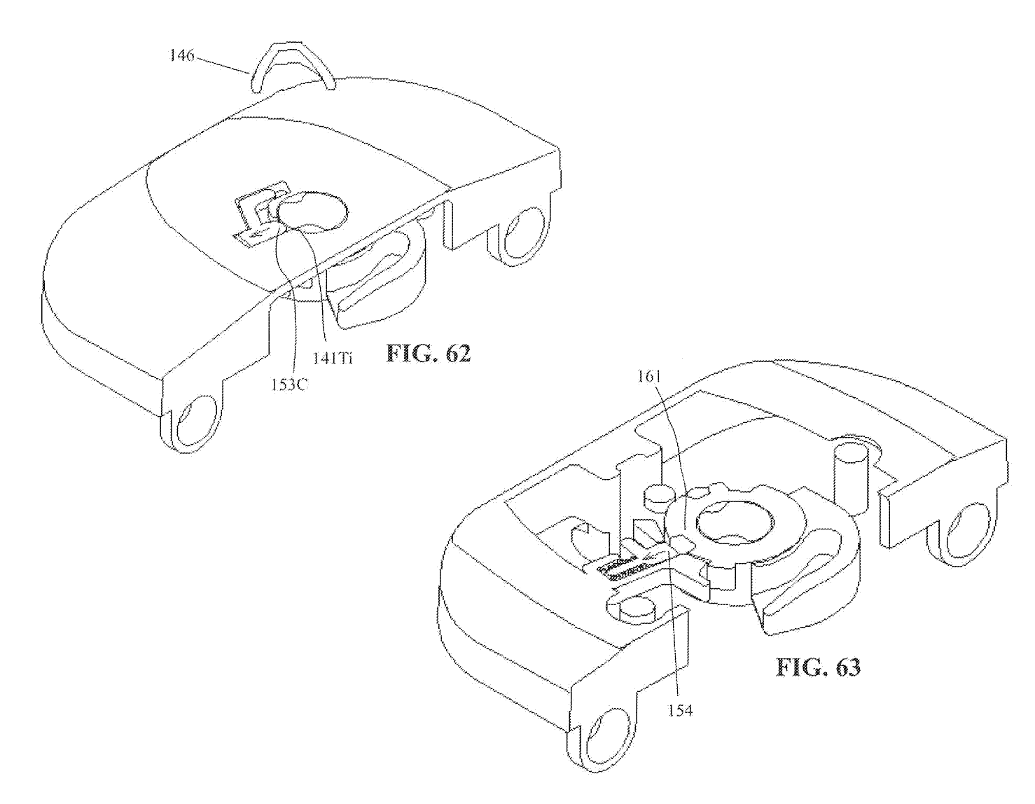

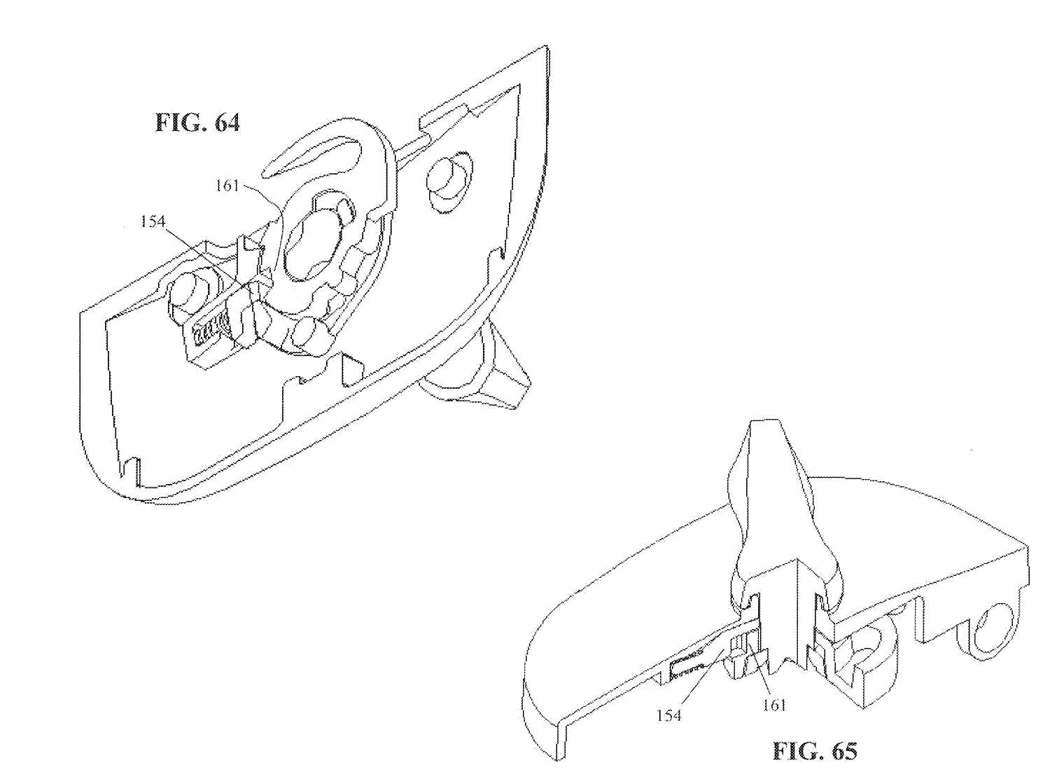

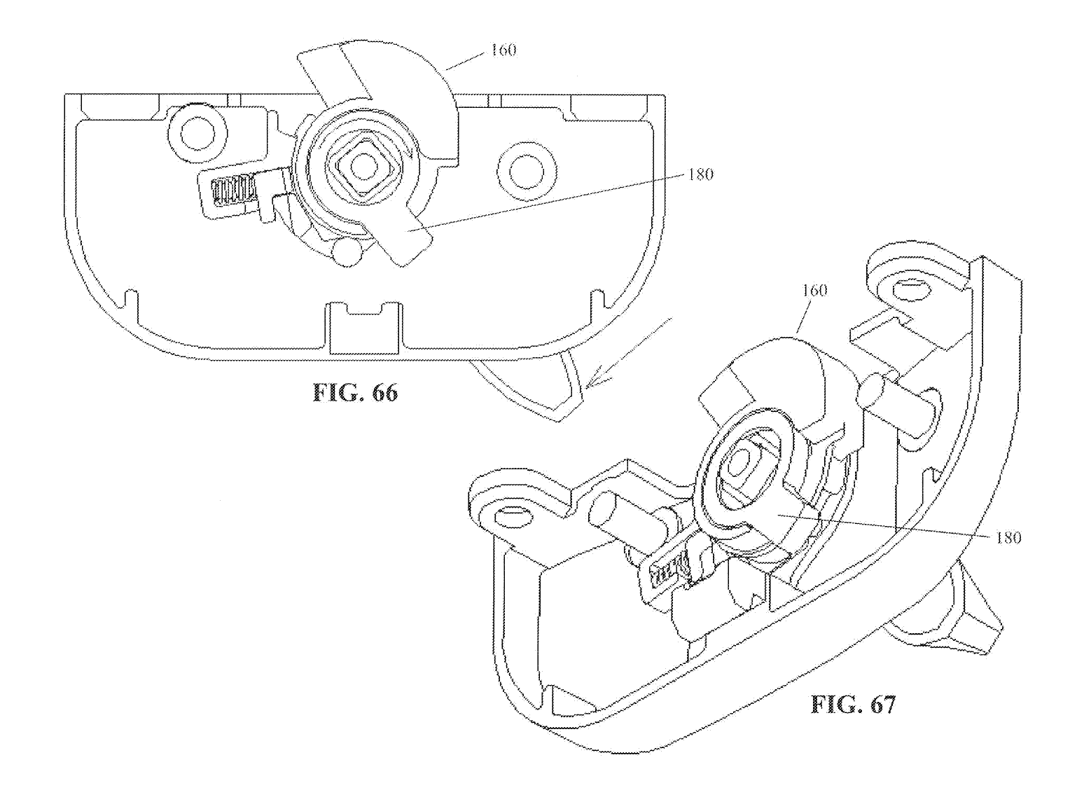

With the cam 160 in the locked (extended) position, upon rotation of the shaft in the second direction (see arrows in FIGS. 60-61), in order to retract the cam within the housing cavity to unlock the sash windows, the first transition surface 141Ti of the shaft 143 of the shaft/handle member 140 contacts the curved surface 153C of the plate member 153 and acts as a cam surface to oppose the spring; bias and drive the plate member to slide within the housing recess 122 (FIG. 62). This causes the protrusion 154 of the plate member 150 to be withdrawn from the first shaped opening 161 of the cam 160 (FIG. 63), and the cam 160 is then unlatched.

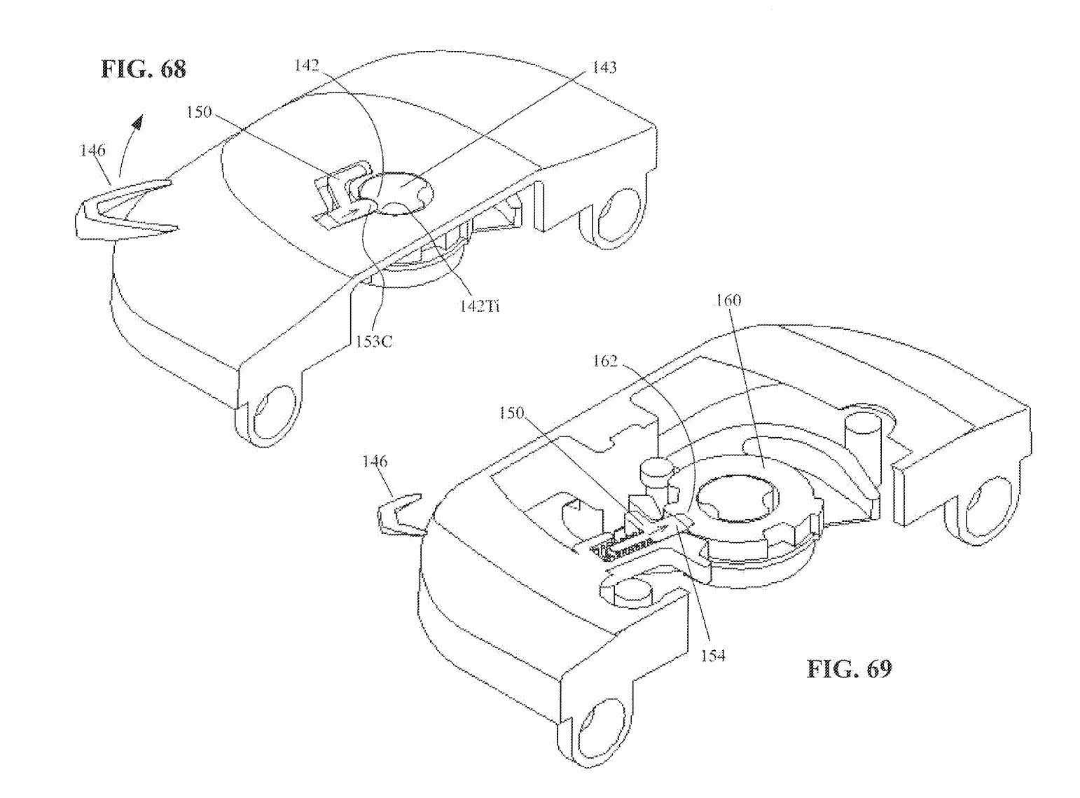

Once the shaft/handle member 1.40 has been rotated the requisite amount (e.g., 50 degrees), the first side 187i of the protrusion. 187 of the lever member 180 contacts the first end 167i of the arcuate recess 167 in the cam 160, and drives the cam to co-rotate. The co-rotation may continue until the cam 160 has been retracted within the housing cavity to unlock the sash window(s). As noted hereinabove, the shaft rotation may continue, until the protrusion 169 on the cam 160 contacts the corresponding housing stop feature (FIG. 70) to limit such rotation. When the shaft/handle member 140 has driven the cam 160 into the retraction-limited position, the curved surface 153C of the plate member 153 may become aligned with and received within the second recess 142 of the shaft 143 of the shaft/handle member 140 as seen in FIG. 68. Upon being biased into such contact, the protrusion 154 of the plate member extends to be received within the second shaped opening 162 of the cam 160 ( FIG. 63), and the cam is once again latched, while positioned at the -unlocked (retracted) position. Note—in an alternate embodiment, the second shaped opening 162 of the cam 160 may instead be an enlarged, over-sized open area, so that cam does not latch in the unlocked (retracted) position, only the locked (extended) position.

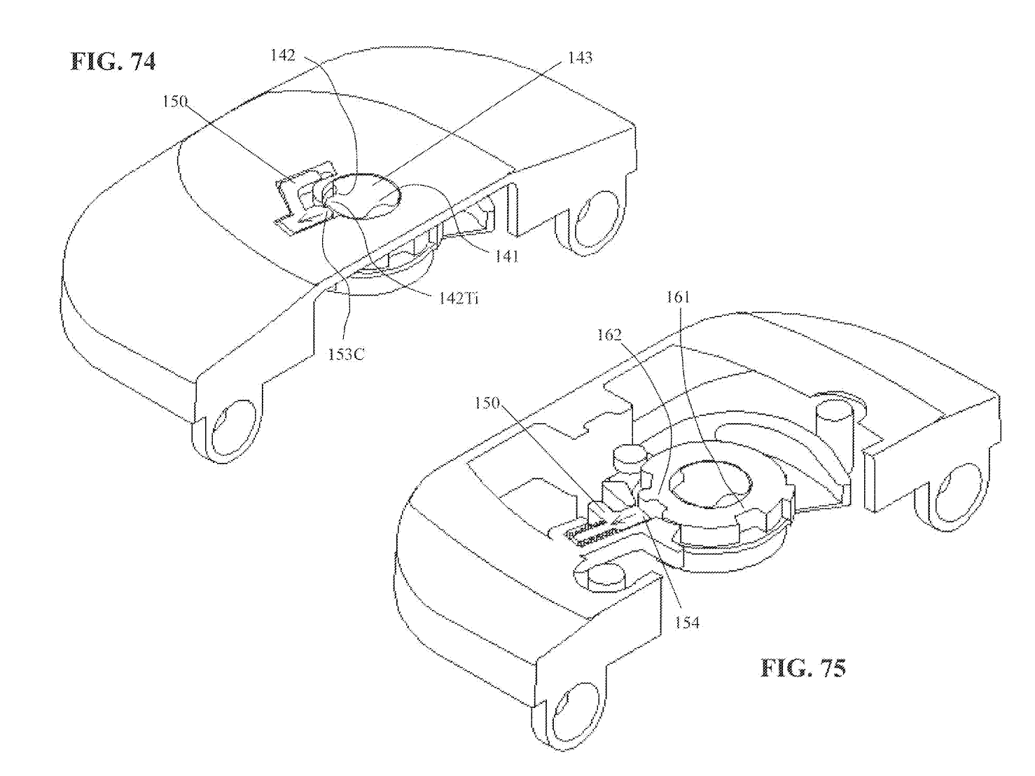

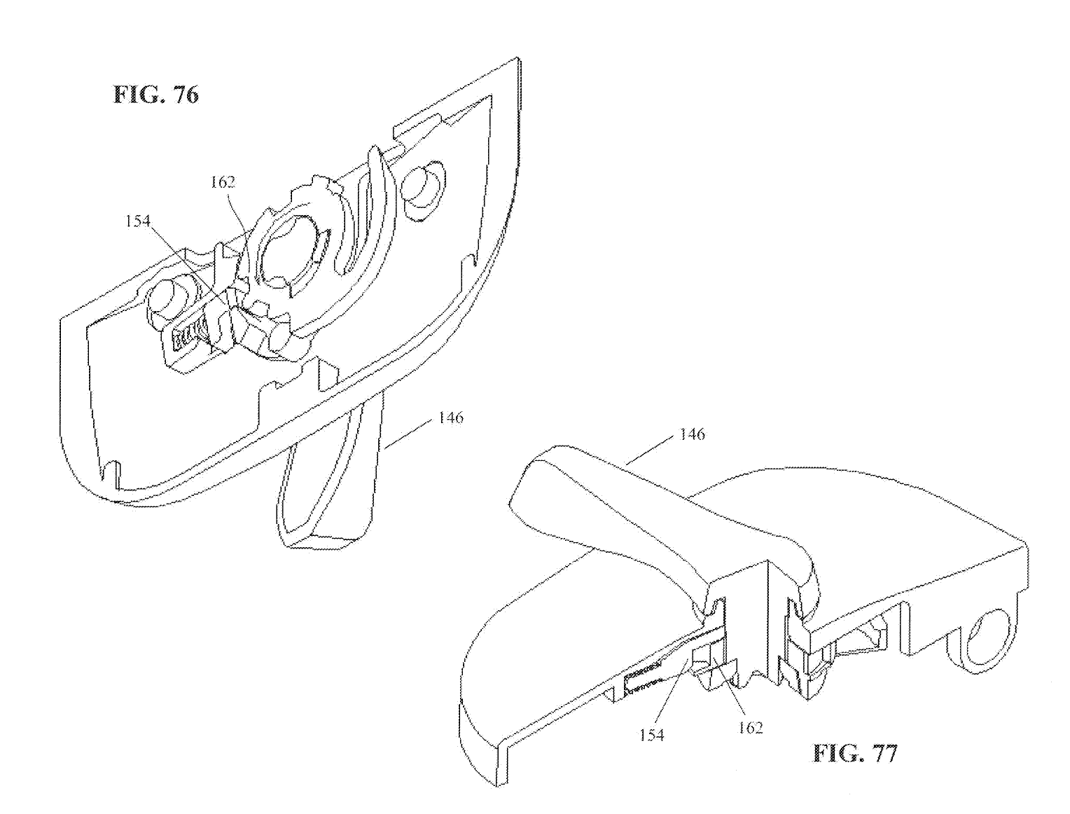

With the cam 160 in the unlocked (retracted) position, upon rotation of the shaft in the first direction (see arrow in FIGS. 72), in order to extend the cam out from the housing cavity to lock the sash windows, the transition, surface 142Ti of the shaft 143 of the shaft/handle member 140 contacts the curved surface 153C of the plate member 153 (see FIG. 68 and FIG. 74) and again acts as a cam surface to oppose the spring bias and drive the plate member to slide within the housing recess 122. This causes the protrusion 154 of the plate member ISO to be withdrawn from the second shaped opening 162 of the cam 160 ( FIG. 75), and the cam is again unlatched.

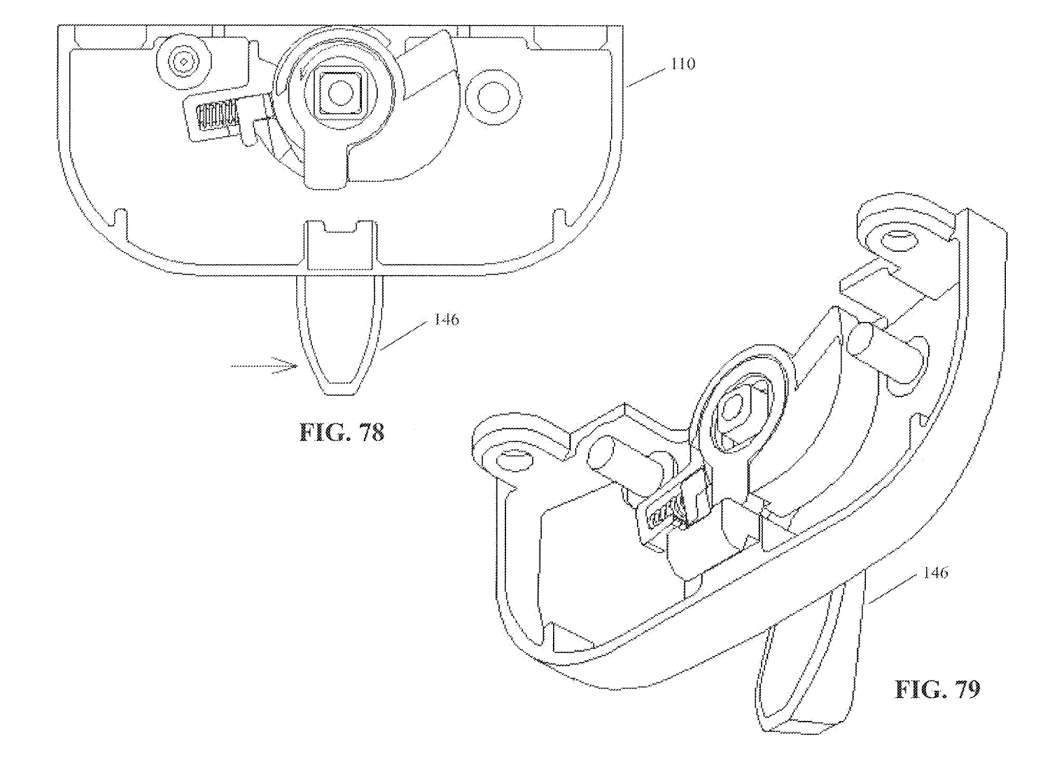

Once the shaft/handle member 140 has been further rotated in the first direction the requisite amount (e.g., 50 degrees—see FIGS. 78-79), the second side 187ii of the protrusion 187 of the lever member 180 may contact the second end 167ii of the arcuate recess 167 in the cam 160, and may again drive the cam to co-rotate. The co-rotation may continue until the earn 160 has been extended out from the housing cavity for the walls 165/166 of the cam 160 to engage the keeper and lock the sash window(s), which may limit rotation of the cam. Also, the co-rotation may be limited by the protrusion 168 on the cam 160 contacting the corresponding housing stop feature (FIG. 53) to limit such rotation. When the shaft/handle member 140 has driven the cam 160 into the extension-limited position, the curved surface 153C of the plate member 153 may once again become aligned with and received within the first recess 141 of the shaft 143 of the shaft/handle member 140, as seen in FIG. 56. Upon being biased into such contact, the protrusion 154 of the plate member may simultaneously extend to be received within the first shaped opening 161 of the cam 160 (FIG. 57), and the cam is once again latched.

While illustrative implementations of one or more embodiments of the present invention are provided hereinabove, those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the exemplary embodiments without departing from the spirit of this invention.

Accordingly, the breadth and scope, of the present disclosure should not be limited by any of the above-described example embodiments, but should be defined only in accordance with the following claims and their equivalents.

What is claimed is:

1. A tamper-resistant sash window lock comprising;
a housing comprising: a wall shaped to form an interior surface that defines a cavity; an orifice interconnected with said cavity; and an elongated recess formed in said interior surface of said wall;
a shaft rotatably mounted in said housing orifice and comprising: a first curved recess, and a second curved recess;
a cam pivotally mounted to said shaft within said housing cavity, and comprising a first shaped opening and a second shaped opening at first and second respective positions, and an arcuate recess;
a lever member fixedly secured to said shaft, and comprising: a protrusion configured to alternately engage each of a first end and a second end of said arcuate recess to respectively drive said cam in each of a first direction and a second direction, respectively;
a compression spring;
a plate member comprising: a first portion configured to be slidably received within said elongated recess of said housing, a first end of said first portion of said plate member formed into a curved surface shaped to correspond to each of said first and second curved recesses; a second portion configured to extend from said first portion of said plate member, and to slidably receive, said compression spring thereon; and a protrusion shaped to be alternately received within, said first shaped opening and said second shaped opening of said cam; and
wherein said compression spring biases said plate member for said protrusion of said plate member to be respectively received within each of said first shaped opening and said second shaped opening of said cam, when rotated to be aligned therewith, and for said curved surface of said plate member to be correspondingly received within said first curved recess and said second curved recess, respectively, when rotated to be aligned therewith, at a locked cam position and an unlocked cam position.

2. The tamper-resistant sash window lock according to claim 1 wherein upon rotation of said shaft, in a first direction, with said cam retracted within said housing at said unlocked cam position, said first curved recess of said shaft engages said curved surface of said plate member to oppose said spring bias to cause said protrusion of said plate member to be withdrawn from said first shaped opening of said cam, to permit said cam to be driven by said protrusion of said lever member in said first direction to said locked cam position.

3. The tamper-resistant lock according to claim 2 wherein upon rotation of said, shaft in said second direction, with a portion of said cam extended out said housing in said locked cam position, said second curved recess of said shaft engages said curved surface of said plate member to oppose said spring bias to cause said protrusion of said plate member to be withdrawn from said second shaped opening of said cam, to permit said cam to be driven by said protrusion of said lever member in said second direction to said unlocked cam position.

4. The tamper-resistant sash window lock according to claim 3 wherein said curved surface comprises a portion of a cylindrical surface.

5. The tamper-resistant lock according to claim 3 wherein said curved surface comprises a portion of a spherical surface.

6. The tamper-resistant sash window lock according to claim 3 wherein said arcuate recess in said cam is configured for said lever member to rotate 50 degrees front said locked cam position in said second direction before said cam is driven by said lever member to co-rotate in said second direction.

7. The tamper-resistant sash window lock according to claim 6 wherein said cam and said lever member are configured for said shaft to rotate 140 degrees for said cam to be driven from said locked cam position to said unlocked cam position.

8. The tamper-resistant sash window lock according to claim 7 wherein said cam and said lever member are configured for said shaft to rotate 50 degrees front said unlocked cam position in said first direction before said cam is driven by said lever member to co-rotate in said first direction.
